(19) United States
(12) Patent Application Publication
(10) Pub. No.: US 2008/0236539 A1
(43) Pub. Date: Oct. 2, 2008

(54) TRANSMISSION CLUTCH PRESSURE CONTROLS VIA PILOT PRESSURE FEEDBACK

(76) Inventors: Quan Zheng, Ann Arbor, MI (US); Michael A. Kozan, Canton, MI (US)

Correspondence Address: DELPHI TECHNOLOGIES, INC., M/C 480-410-202, PO BOX 5052, TROY, MI, 48007, US

(21) Appl. No.: 11/691,153

(22) Filed: Mar. 26, 2007

(51) Int. Cl. F16H 59/00

(52) U.S. Cl. 123/197.1

(57) ABSTRACT

A transmission clutch pressure control apparatus is suitable for a configuration that includes a pilot valve and a pressure regulating valve working in tandem. The pilot valve produces a pilot pressure that varies in accordance with a pilot valve drive signal. The pressure regulating valve provides fluid to a clutch at an output clutch pressure that is in turn variable based on the pilot pressure. The apparatus includes a pilot pressure sensor in fluid communication with the pilot valve output and generates a pilot pressure signal. The apparatus also includes a control arrangement having a pilot valve pressure estimation block configured to produce a pilot pressure command in response to a clutch pressure command. The estimation block is configured to reflect the relationship between the clutch pressure and the pilot pressure. The control arrangement also includes a summer that produces an error signal based on the difference between the commanded and sensed pilot pressure. The control arrangement also includes additional control blocks implementing a control strategy that ultimately develops and output the pilot valve drive signal all based on the pilot pressure command and the pilot pressure error signal.

### TECHNICAL FIELD

The present invention relates generally to improvements in clutch pressure controls in a vehicle automatic transmission and more particularly to a transmission clutch pressure control via pilot pressure feedback.

### BACKGROUND OF THE INVENTION

Hydraulic fluid controls can be found in a variety of automotive applications such as automatic speed change transmissions as well as others. In these applications, it is often desirable to control the pressure of the hydraulic fluid, as seen by reference to U.S. Pat. No. 6,308,725 entitled “APPARATUS FOR CONTROLLING HYDRAULIC FLUID PRESSURE” issued to Lawlyes et al., assigned to the common assignee of the present invention. Lawlyes et al. disclose a smart actuator including a solenoid element and a pressure sensor element, both of which are in electrical communication with a remote control through a wire harness. Lawlyes et al. provide for remote pressure sensing of a solenoid output.

In the specific context of an automatic speed change power transmission, it is known to use transmission control units that are configured to generate electrical signals that control actuators/solenoids resulting in the control of fluid flow as well as the pressure in a hydraulic fluid line. As known, the pressure of a hydraulic fluid line can be used to control various other elements in an automatic transmission system including for example the engagement of individual gears. By engaging various combinations of gears (e.g., planetary gears in a planetary gear transmission), an automatic transmission system accomplishes the same task as the shifting of gears in a manual transmission. Hydraulically-actuated clutches are also found in transmissions and are typically used for engaging a pair of gears (e.g., a pair of rotating members, or alternatively, one rotating member and one non-rotating member) together such that when the clutch is applied torque can be transmitted from one shaft to the other. Shift changes may also include switching three or more clutches on occasion for certain types of shifts, and herein references to two clutch type shifts could also include the multiple shifts.

An important operating aspect of a hydraulically operated clutch relates to the pressure of the applied hydraulic fluid. In general, such applied pressure is sought to be controlled and varied to achieve a predetermined fluid flow to the clutch in order to obtain a desired engagement characteristic, principally with respect to timing and smoothness. It should be appreciated that if the timing of the engagement of one gear with the disengagement of another gear is not coordinately properly, overall shift performance may suffer. It is thus desirable and known in the art to control the pressure of the hydraulic fluid being supplied to such clutch. However, in some configurations, the hydraulically-actuated clutch needs such a relatively large volume of hydraulic fluid that a combination of a pilot valve and a larger flow, pilot operated valve are used in tandem to control the clutch pressure. In this arrangement, the pilot valve is controlled by a controller or the like to produce a variable pilot pressure output which in turn is supplied to and operates the pilot-operated, larger flow valve. The pilot operated valve, in response, provides a variable output pressure, which is supplied to the hydraulically actuated clutch.

One approach for controlling the clutch pressure in this configuration involves using a pressure sensor disposed to sense the clutch pressure and to generate a clutch pressure signal that is fed back to a controller. However, in some configurations, it is difficult to mount a pressure sensor in the clutch chamber due to various physical constraints.

There is therefore a need for a hydraulic clutch pressure control system that minimizes or eliminates one or more of the problems set forth above.

### SUMMARY OF THE INVENTION

One advantage of the present invention is that it provides a pressure control having the benefits of a direct measure clutch pressure closed-loop system without the difficulties associated with mounting a pressure sensor in the clutch chamber.

An apparatus for hydraulic clutch pressure control includes a pilot valve, a pilot pressure sensor, a pressure regulating valve and a control arrangement. The pilot valve has an outlet that is configured to provide hydraulic fluid at a pilot pressure that is variable based on a pilot valve drive signal. The pilot pressure sensor is configured to sense the pilot pressure and generate a pilot pressure signal indicative of the sensed pilot pressure. The pressure regulating valve has an output configured for connection to the clutch and to provide hydraulic fluid at an output pressure that is variable based on the pilot pressure. Finally, the control arrangement is configured to generate the pilot valve drive signal in response to (i) a clutch pressure command signal indicative of a desired output pressure to be provided to the clutch (“clutch pressure”), and (ii) the pilot pressure signal (as a feedback) indicative of the sensed pilot pressure.

In a preferred embodiment, the control arrangement includes (i) a feed forward control block configured to generate an open loop pilot valve control signal; (ii) a closed loop controller responsive to a pilot pressure error (difference) signal configured to generated a closed loop pilot valve control signal; and (iii) a summer responsive to both the open loop pilot valve control signal and the closed loop pilot valve control signal and configured to produce an output pilot valve control signal. The control arrangement further includes a translation block that converts the output pilot valve control signal into a pilot valve drive signal suitable for the type of pilot valve being used.

Other features and aspects of the invention are also presented.

### BRIEF DESCRIPTION OF THE DRAWINGS

The present invention will now be described by way of example, with reference to the accompanying drawings:

FIG. 1 is a block diagram of an apparatus for hydraulic clutch pressure control in accordance with the invention.

FIG. 2 is a block diagram showing, in greater detail, a control arrangement portion of the apparatus of FIG. 1.

### DETAILED DESCRIPTION OF THE PREFERRED EMBODIMENT

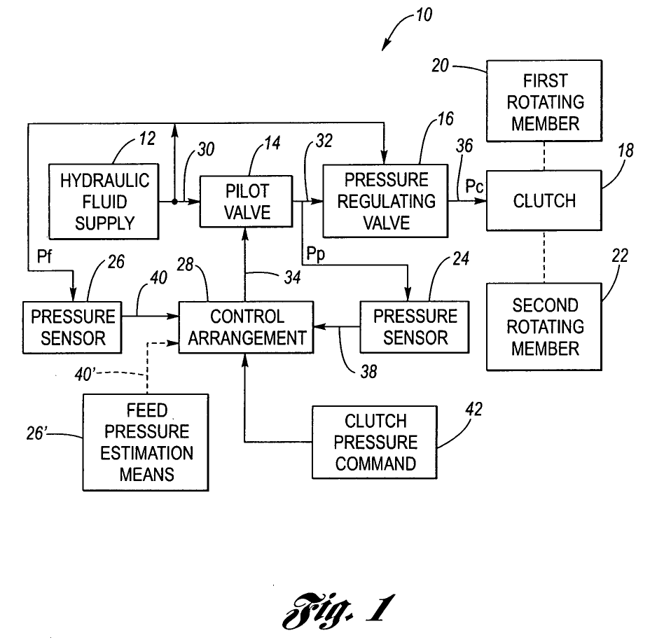

Referring now to the drawings wherein like reference numerals are used to identify identical components in the various views, FIG. 1 is a simplified block diagram of an apparatus 10 for controlling hydraulic fluid clutch pressure. The apparatus 10 provides the benefits of direct measure clutch pressure closed loop control without the difficulty of mounting a pressure sensor in the clutch chamber. In an illustrated embodiment, FIG. 1 shows a hydraulic fluid supply 12, a pilot valve 14, a pressure regulating valve 16, a hydraulically-actuated clutch 18, a pair of rotating members 20, 22, a pilot pressure sensor 24, an optional feed or supply fluid pressure sensor 26 and a control arrangement 28. It should be understood that the pair of rotating members in the illustrated embodiment is exemplary only and not limiting in nature. For example, in alternate embodiments, one of the members 20, 22 may comprise a non-rotating member, as described in the Background.

The illustrated embodiment of apparatus 10 may be suitably employed in an automatic speed change power transmission of the type described in the Background. That is, a transmission of the type having hydraulic fluid actuated clutches, such as clutch 18, configured such that when applied are operative to engage first and second members (e.g., planetary gears, or other rotating members in one embodiment, or one rotating and one non-rotating member in an alternate embodiment) together so that rotating torque may be transmitted from one member to the other. As also described in the Background, controlling and varying the hydraulic fluid pressure supplied to clutch 18 materially affects the operating characteristic of the clutch and in turn the resulting engagement of gears.

With continued reference to FIG. 1, hydraulic fluid supply 12 includes an outlet that supplies hydraulic fluid through line 30 to pilot valve 14, pressure regulating valve 16 and optionally pressure sensor 26. Fluid supply 12 may comprise conventional components known to those of ordinary skill in the art, for example, pumps, pressure regulating devices, valves and the like. Fluid supply 12 provides hydraulic fluid at a nominal feed pressure (P_{F}) in accordance with the design requirements of any particular constructed embodiment.

Pilot valve 14 includes (i) an inlet to receive the supply of hydraulic fluid at the feed pressure, which in the FIG. 1 is designated Pf, via line 30 as well as (ii) an outlet coupled to a line 32. Pilot valve 14 is configured to provide hydraulic fluid at a pilot pressure (P_{P}) that is variable in accordance with a pilot valve drive signal 34. Pilot valve 14 may comprise conventional components known to those of ordinary skill in the art. In one embodiment, pilot valve 14 may comprise a pressure control solenoid (for example a variable bleed solenoid, or variable flow solenoid), a current controlled device that produces an output pressure as a function of an applied current (i.e., pilot valve drive signal 34). In an alternate embodiment, pilot valve 14 may comprise a pulse-width modulated (PWM) actuator that produces an output pressure corresponding to the duty cycle of an input drive signal. It should be understood that the present invention is not limited to these two embodiments, which are merely exemplary and not limiting in nature.

Pressure regulating valve 16 is provided with (i) an inlet for receiving a supply of hydraulic fluid as well as (ii) an output configured for connection to clutch 18 via line 36. Valve 16 is configured to provide fluid on line 36 at an output pressure (P_{C}) to the clutch that is variable in accordance with the pilot pressure (P_{P}). Pressure regulating valve 16 is configured to provide flow at a greater level than available with pilot valve 14, in accordance with the requirements of clutch 18 (e.g., 5-6 liters per minute). Valve 16 may comprise conventional components known in the art, for example, in one embodiment, valve 16 may comprise a pilot operated spool valve.

Pilot pressure sensor 24 is in fluid communication with line 32 and is configured to sense the pilot pressure (P_{P}) and generate a pilot pressure signal 38 indicative of the sensed pilot pressure. Pressure sensor 24 may comprise conventional components known in the art.

Feed pressure sensor 26 may be optionally included in apparatus 10. Sensor 26 (if provided) is in fluid communication with supply line 30 and is configured to sense the feed pressure (P_{F}) and generate a feed pressure signal 40 indicative of the sensed feed pressure. Feed pressure sensor 26 may comprise conventional components known in the art. In an alternate embodiment, pressure sensor 26 is omitted and is substituted with means 26′ for generating a feed pressure estimation parameter 40′ that is indicative of the feed pressure. In this alternative embodiment, pressure estimation parameter 40′ is provided to control arrangement in lieu of pressure signal 40.

An estimated feed pressure (e.g., the pressure estimation parameter 40′) may be achieved by a mathematical model describing the relationship of the commanded supply pressure and the output supply pressure. Such model can have various forms, such as mathematical equations, empirical data and a combination of both. The developed model can be executed in control software running inside the transmission control unit (not shown in FIG. 1), and can use various known control methodologies, including Proportional-Integral (P-I) type control, and Proportional-Integral-Differential (P-I-D) type control.

Control arrangement 28 is configured to generate pilot valve drive signal 34 in response to (i) a clutch pressure command signal 42 indicative of a desired output pressure (“clutch pressure”) and (ii) pilot pressure signal 38 (as a feedback signal) indicative of the sensed pilot pressure. The principle of the present invention is that there is a relationship between clutch pressure (P_{C}) and pilot pressure (P_{P}) that can be characterized with sufficient definiteness to implement in control arrangement 28. Therefore, “closed loop” clutch pressure control can be achieved, effectively, by way of closed loop pilot pressure control. In one embodiment, the relationship may be characterized in terms of a mathematical model describing the relationship between the clutch pressure and the pilot pressure. The developed model can be executed in control arrangement 28, as described in greater detail below. The present invention provides the benefits of direct clutch pressure measurement as feedback without the complications of trying to overcome the physical limitations involved in mounting a pressure sensor in the clutch chamber.

With continued reference to FIG. 1, in basic operation, in an automotive automatic transmission system, a desired clutch pressure command 42 is generated by a transmission control unit (TCU—not shown) or the like. As understood in the art, the desired clutch pressure may be based on a variety of factors such as engine rpm, vehicle speed and other driving conditions. Control arrangement 28, configured with the intelligence linking the relationship between clutch pressure and pilot pressure, as described above, internally develops what the desired pilot pressure should be in order to achieve the commanded clutch pressure per the overall transmission control strategy. Control arrangement 28 is further configured to compare the internally developed target pilot pressure with the sensed pilot pressure and produce an error signal representing the difference. The control arrangement uses this error signal in a feedback loop to alter the pilot valve drive signal to reduce the error. Through the foregoing, effective “closed loop” control of the clutch pressure through pilot pressure feedback can be achieved.

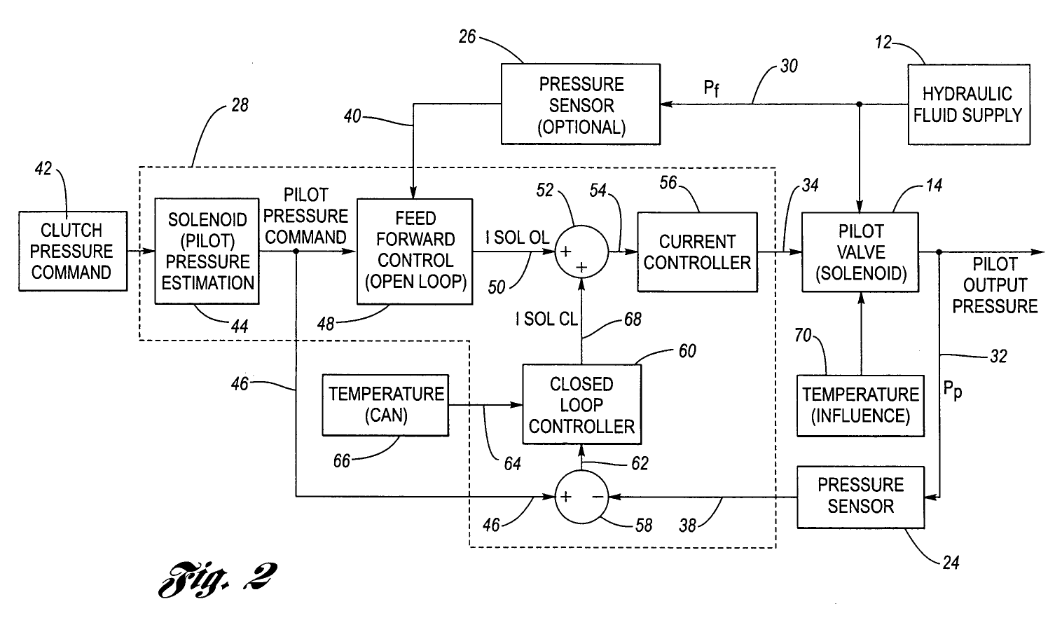

FIG. 2 is a simplified block diagram showing, in greater detail, control arrangement 28 of FIG. 1. Control arrangement 28 includes a pilot pressure estimation block 44. Estimation block 44 is responsive to clutch pressure command signal 42 and is configured to generate a pilot pressure command signal 46 indicative of a desired pilot pressure needed to obtain the commanded (i.e., commanded by clutch pressure command signal 42) clutch pressure (P_{C}). Estimation block 44 is configured to implement the mathematical model describing the relationship between the clutch pressure and the pilot pressure, as described above. In this regard, it should be understood that estimation block 44 may be implemented in hardware, software, firmware, or any combination thereof.

More specifically, the mathematical model describing the relationship between the clutch pressure and the pilot pressure for block 44 can be derived based on the design of the hydraulic circuit using physical laws. Such representation can have various forms, such as force balance equations, Bernoulli and Euler equations, and other physical equations that represent the responses (pressure and time) that the system should see. Because the system is highly complex, models which are based on empirical data, by measuring actual responses of the system in the early development stages, and then modeling the system response via look-up tables and higher order polynomials, is also possible means to model the system. It is also possible to do a combination of the two.

Control arrangement 28 further includes a feed forward control block 48 producing an open loop pilot valve control signal 50, a summer 52 producing an output pilot valve control signal 54, a translation block 56, another summer 58 and a closed loop controller 60.

Feed forward control block 48 is responsive to pilot pressure command signal 46 and feed pressure signal 40 (or estimation parameter 40′) for generating control signal 50. In the illustrated embodiment, control signal 50 is shown as i_sol_OL, which is applicable when pilot valve 14 is implemented using a current controlled valve, as described above. It should be understood, however, that block 48 is not so limited, and may be configured to generate control signal 50 applicable for a PWM duty cycle controlled pilot valve, also as described above.

Summer 58 is configured to generate a pilot pressure error signal 62 indicative of a difference between the commanded and sensed pilot pressures. In this regard, summer 58 is responsive to pilot valve command signal 46 and pilot pressure signal 38 (at the inverting input) in generating the error signal 62.

Closed loop controller 60 is responsive to the generated error signal 62 and a temperature signal 64 produced by a temperature sensor 66 or other available source of temperature to generate a closed loop pilot valve control signal 68. Temperature signal 64 via temperature sensor 66 is typically available in automotive applications via a Controller Area Network (CAN), for example.

Summer 52 is configured to sum and generate output pilot valve control signal 54 based on and responsive to (i) open loop pilot valve control signal 50 and (ii) closed loop pilot valve control signal 68. Output control signal 54 is provided to translation block 56.

It should be understood that feed forward block 48, closed loop controller 60 and summers 52, 58 may be configured to interact and cooperate with each other all in accordance with conventional control principles to generate the output control signal 54. For example, the foregoing components may implement proportional integral (PI) control, proportional integral derivative (PID) and any other suitable, conventional control strategy. Other variations are possible in accordance with that known to one of ordinary skill.

Translation block 56 is configured generally to convert or translate output pilot valve control signal 54 to pilot valve drive signal 34. In an embodiment where the pilot valve is a current controlled pilot valve (as described above), the translation block may take the form of a current controller, as shown, which may include pressure-to-current conversion facilities implemented in software, firmware, hardware or a combination thereof. In an alternate embodiment where pilot valve 14 comprises a PWM duty cycle controlled valve, the translation block 56 may comprise pressure-to-PWM conversion facilities including a PWM duty cycle controller. One of ordinary skill in the art will recognize that variations are possible, depending on the type of pilot valve used, that remain within the spirit and scope of the invention.

With continued reference to FIG. 2, block 56 outputs pilot valve drive signal 34 (also shown in FIG. 1), which is applied to pilot valve 14 causing it to output hydraulic fluid at the driven pilot pressure. It should be appreciated that temperature can also influence the operation and performance of pilot valve 14—this temperature influence is shown in block form and is designated “70” in FIG. 2. The pilot pressure (P_{P}) is then fed back via pressure sensor 24, all as described above.

In accordance with the invention, a new and improved hydraulic clutch pressure control system is provided which obtains the benefit of direct measure clutch pressure feedback without the difficulties associated with mounting a pressure sensor in a clutch chamber.

While particular embodiments of the invention have been shown and described, numerous variations and alternate embodiments will occur to those skilled in the art. Accordingly, it is intended that the invention be limited only in terms of the appended claims.

1. An apparatus for controlling hydraulic fluid to a clutch in a vehicle automatic speed change transmission where the clutch is configured to transmit torque between a pair of members, comprising:
a pilot valve having an outlet configured to provide fluid at a pilot pressure that is variable in accordance with a pilot valve drive signal;
a pilot pressure sensor configured to sense said pilot pressure and generate a pilot pressure signal indicative of said sensed pilot pressure;
a pressure regulating valve with an output configured for connection to the clutch, said regulating valve being configured to provide fluid at an output pressure that is variable in accordance with said pilot pressure;
a control arrangement configured to generate said pilot valve drive signal in response to (i) a clutch pressure command signal indicative of a desired output pressure to be provided to the clutch, and (ii) said pilot pressure signal indicative of said sensed pilot pressure.

2. The apparatus of claim 1 wherein said pilot valve further includes an inlet configured to receive hydraulic fluid at a feed pressure, said apparatus further including a feed pressure sensor configured to sense said feed pressure and generate a feed pressure signal indicative of said sensed feed pressure, said control arrangement being further responsive to said feed pressure signal to generate said pilot valve drive signal.

3. The apparatus of claim 1 wherein said pilot valve further includes an inlet configured to receive hydraulic fluid at a feed pressure, further including means for generating a feed pressure estimation parameter indicative of said feed pressure, said control arrangement being further responsive to said feed pressure estimation parameter to generate said pilot valve drive signal.

4. The apparatus of claim 1 wherein said control arrangement includes a pilot pressure estimation block responsive to said clutch pressure command configured to generate a pilot pressure command signal indicative of a desired pilot pressure operative in order to obtain said desired output pressure of said pressure regulating valve that is provided to the clutch.

5. The apparatus of claim 4 further including:
a feed forward control block responsive to said pilot pressure command signal configured to generate an open loop pilot valve control signal;
a first summer responsive to said pilot pressure command signal and said pilot pressure signal for generating an error signal indicative of a difference between commanded and sensed pilot pressure;
a closed loop controller responsive to said error signal configured to generate a closed loop pilot valve control signal; and
a second summer responsive to (i) said open loop pilot valve control signal and (ii) said closed loop pilot valve control signal configured to generate an output pilot valve control signal;
a translation block configured to generate said pilot valve drive signal in accordance with said output pilot valve control signal.

6. The apparatus of claim 6 wherein said closed loop controller is further responsive to a temperature signal to generate said closed loop pilot valve control signal.

7. The apparatus of claim 6 wherein said pilot valve is a current controlled pilot valve whose output pressure corresponds to an input current over a predetermined range, wherein said translation block comprises a current controller for translating said output pilot valve control signal into a current drive signal defining said pilot valve drive signal.

8. The apparatus of claim 6 wherein said pilot valve is a pulse width modulation (PWM) controlled pilot valve whose output pressure corresponds to a duty cycle of an input voltage signal over a predetermined range, wherein said translation block comprises a PWM duty cycle controller for translating said output pilot valve control signal into a PWM voltage signal defining said pilot valve drive signal.

9. The apparatus of claim 1 wherein said pressure regulating valve comprises a pilot pressure operated spool valve.

10. The apparatus of claim 5 wherein said control arrangement implements a control strategy selected from the group comprising a proportional integral (PI) control strategy and a proportional integral derivative (PID) control strategy.
